(19) United States
(12) Patent Application Publication
(10) Pub. No.: US 2007/0184163 A1
(43) Pub. Date: Aug. 9, 2007

(54) Non-hygroscopic flavor particles

(75) Inventors: Adam J. Toth, Aberdeen, NJ (US); Lulu Henson, Plainsboro, NJ (US); Lewis Michael Popplewell, Morganville, NJ (US)

Correspondence Address: INTERNATIONAL FLAVORS & FRAGRANCES INC., 521 WEST 57TH ST, NEW YORK, NY, 10019, US

(73) Assignee: International Flavors, & Fragrances Inc.

(21) Appl. No.: 11/349,403

(22) Filed: Feb. 7, 2006

(51) Int. Cl. A23L 1/22

(52) U.S. Cl. 426/534

(57) ABSTRACT

The invention relates to flavorings. In particular, the invention relates to extruded flavors that are capable of retaining their particle shape and integrity when exposed to high temperature and humid environments.

### FIELD OF THE INVENTION

The invention relates to flavorings. In particular, the invention relates to extruded flavors that are capable of retaining their particle shape and integrity when exposed to high temperature and humid environments.

### DESCRIPTION OF THE PRIOR ART

The present invention pertains to the use of certain materials and methods of applying these materials to improve the physical properties of edible solid particles exposed to high humidity conditions. At highest risk are particles that have a high surface area, contain amorphous sugars or carbohydrates or other ingredients that tend to absorb moisture from the environment, and are processed or held in such a way that exposes the particles for an extended period of time to a humid environment without adequate moisture protection. Such particles include flavor encapsulates, dry mixes, spices, and seasonings, flavored tea, powdered soft drinks, confectionery, pharmaceuticals, dietary supplements, among others.

Adding anti-caking or flow agents to pharmaceutical preparations to improve flow properties in the event that these products absorb moisture from the environment is known. U.S. Pat. No. 2,555,463 describes normally hygroscopic Na pantothenate which is converted into a dry, stable, non-hygroscopic, granulated product by mixing it intimately with 2-60% by weight of methylcellulose or an alkali metal salt of carboxymethylcellulose.

In certain cases, the protection provided by these flow agents is insufficient to meet the needs of the specific application based on above-mentioned limitations or other product-specific needs. In the case of flavored tea bags, several factors make it necessary to have robust flavor granules that can withstand the deleterious effects of moisture uptake. Tea leaves or herbal tea blends contain moisture that can be readily absorbed by the flavor granules that in turn can cause flavor granules to become sticky and cause bag spotting or tearing. Secondly, the processes involved in mixing flavor granules with tea and dispensing into tea bags could expose both tea and flavor granules to the atmosphere sufficient to adversely affect the filling process and shut down operations or cause bag spotting if the environment is hot and humid. Thirdly, packaged tea bags must be stable for at least 2 years under ambient conditions which could entail storage at high humidity. Lastly, is the unavoidable use of certain flavors that by their nature contain materials that promote plasticization of the matrix materials that make up the flavor granule. Of the various factors enumerated, the last is considered one of the major causes of potential product failure because plasticizing materials often greatly accelerate moisture uptake. The common practice of coating or blending the flavor granules with traditional flow agents is often not sufficient to prevent the flavor granules from becoming sticky or is not compatible with the requirement that the flow agent does not affect the properties of the tea upon reconstitution, i.e., maintaining solution clarity and flavor neutrality.

It has been found that it is possible to minimize or eliminate the adverse effect of plasticizing flavor actives or other matrix materials on moisture uptake by incorporating certain functional ingredients to the flavor granule matrix prior to melt encapsulation via extrusion or other similar processes to produce non-hygroscopic particles. Moreover, it has also been possible to overcome the plasticizing effect of flavor solvents such as triacetin and propylene glycol. Thirdly, a synergistic effect was discovered between inclusion of these functional ingredients into the extrusion matrix and with specific flow agents that are applied externally or post-extrusion. The effect may be seen not only in the decreased level of moisture that is absorbed by the flavor granule from the environment, but also in the ability of the flavor granules to remain relatively hard, discrete, and intact in spite of the moisture absorbed by the granule.

### SUMMARY OF THE INVENTION

An object of the present invention is to provide a method of forming a free flowing granule flavor composition comprising mixing in any order the following ingredients a flavor, a carrier, and a functional ingredient selected from the group consisting of distilled monoglycerides, mono- and diglycerides, sodium carboxymethylcellulose, hydroxypropylcellulose, methylcellulose, hydroxypropyl methylcellulose, ethylcellulose, silicon dioxide; extruding the ingredients at a temperature sufficient to form a melt which on cooling solidifies and can be reduced in particle size by milling to form a free flowing granule material and optionally blending the extruded ingredients with silicon dioxide, calcium stearate, and magnesium stearate and providing free flowing granule flavors.

It is a further embodiment of the invention to provide flavor granules having a particle size distribution such that at least 60%, more preferably 80% of the particles pass through about US 20 ASTM mesh sieve (herein referred to as a US 20 mesh sieve) after exposure to a humid environment.

An additional embodiment of the present invention is directed to a flavored tea bag. According to this aspect of the invention, a conventional tea bag comprising a porous bag and a preselected amount of cut tea leaves further includes an amount of the free flowing flavor granules of the invention sufficient to impart a brewed portion of tea the flavor of the free flowing flavor granules.

### DETAILED DESCRIPTION OF THE INVENTION

Suitable conventional flavoring materials include saturated fatty acids, unsaturated fatty acids and amino acids; alcohols, including primary and secondary alcohols; esters; carbonyl compounds including ketones and aldehydes; lactones; other cyclic organic materials including benzene derivatives, acyclic compounds, heterocyclics such as furans, pyridines, pyrazines and the like; sulfur-containing compounds including thiols, sulfides, disulfides and the like; proteins; lipids, carbohydrates; so-called flavor potentiators such as monosodium glutamate, magnesium glutamate, calcium glutamate, guanylates and inosinates; natural flavoring materials such as cocoa, vanilla and caramel; essential oils and extracts such as anise oil, clove oil and the like and artificial flavoring materials such as vanillin, ethyl vanillin and the like.

Specific preferred flavor adjuvants include, but are not limited to, the following: anise oil; ethyl-2-methyl butyrate; vanillin; cis-3-heptenol; cis-3-hexenol; trans-2-heptenal; butyl valerate; 2,3-diethyl pyrazine; methyl cyclo-pentenolone; benzaldehyde; valerian oil; 3,4-dimeth-oxyphenol; amyl acetate; amyl cinnamate; γ-butyryl lactone; furfural; trimethyl pyrazine; phenyl acetic acid; isovaleraldehyde; ethyl maltol; ethyl vanillin; ethyl valerate; ethyl butyrate; cocoa extract; coffee extract; peppermint oil; spearmint oil; clove oil; anethol; cardamom oil; wintergreen oil; cinnamic aldehyde; ethyl-2-methyl valerate; γ-hexenyl lactone; 2,4-decadienal; 2,4-heptadienal; methyl thiazole alcohol (4-methyl-5-β-hydroxyethyl thiazole); 2-methyl butanethiol; 4-mercapto-2-butanone; 3-mercapto-2-pentanone; 1-mercapto-2-propane; benzaldehyde; furfural; furfuryl alcohol; 2-mercapto propionic acid; alkyl pyrazine; methyl pyrazine; 2-ethyl-3-methyl pyrazine; tetramethyl pyrazine; polysulfides; dipropyl disulfide; methyl benzyl disulfide; alkyl thiophene; 2,3-dimethyl thiophene; 5-methyl furfural; acetyl furan; 2,4-decadienal; guiacol; phenyl acetaldehyde; β-decalactone; d-limonene; acetoin; amyl acetate; maltol; ethyl butyrate; levulinic acid; piperonal; ethyl acetate; n-octanal; n-pentanal; n-hexanal; diacetyl; monosodium glutamate; monopotassium glutamate; sulfur-containing amino acids, e.g., cysteine; hydrolyzed vegetable protein; 2-methylfuran-3-thiol; 2-methyldihydrofuran-3-thiol; 2,5-dimethylfuran-3-thiol; hydrolyzed fish protein; tetramethyl pyrazine; propylpropenyl disulfide; propylpropenyl trisulfide; diallyl disulfide; diallyl trisulfide; dipropenyl disulfide; dipropenyl trisulfide; 4-methyl-2-[(methylthio)-ethyl]-1,3-dithiolane; 4,5-dimethyl-2-(methylthiomethyl)-1,3-dithiolane; and 4-methyl-2-(methylthiomethyl)-1,3-dithiolane. These and other flavor ingredients are provided in U.S. Pat. Nos. 6,110,520 and 6,333,180 hereby incorporated by reference.

The level of flavor employed in the dry particle of the invention varies from about 0.1 to about 30 weight percent, preferably from about 5 to about 20 and most preferably from about 10 to about 15 weight percent.

When flavors are employed the level of flavor particles of the invention will vary depending on many factors including other ingredients, their relative amounts and the effect that is desired. Those with skill in the art will incorporate suitable materials in the invention when the product incorporating the present invention is intended for human or animal consumption.

The amount of the functional ingredient(s) ranges from about 1% to about 10% by weight, more preferably from about 0.5 to about 2% by weight. Suitable functional ingredients include distilled monoglycerides, mono- and diglycerides, sodium carboxymethylcellulose, hydroxypropylcellulose, methylcellulose, hydroxypropyl methylcellulose, ethylcellulose, silicon dioxide, calcium stearate, magnesium stearate, mixtures thereof and the like.

The preferred materials for inclusion in the matrix prior to extrusion are distilled monoglycerides, mono- and diglycerides, sodium carboxymethylcellulose, and hydroxypropylcellulose. It should be noted that these ingredients are not known in the art to impart this effect on flavor materials encapsulated in a sugar or carbohydrate matrix prepared by melt encapsulation. Typical known uses for cellulosic polymers are as thickeners, film-formers, and suspending aids. Mono- and diglycerides are used as emulsifiers. The mechanism of action of the present invention is not completely understood at this time and most likely the way these ingredients provide moisture resistance to the flavor granules differ depending on compound class. One theory is that the cellulosic polymers preferentially bind the absorbed water from the environment thereby making the water less available for binding to or dissolution of the sugars and other hygroscopic materials in the matrix. The high molecular weight of these polymers and their film-forming properties may further enhance this effect.

Microcrystalline cellulose or powdered cellulose is commonly used as flow aids, such as in shredded or grated cheese. Surprisingly, in this case the microcrystalline cellulose did not produce free flowing flavor granules as compared to the use of sodium carboxymethylcellulose and distilled monoglycerides.

Distilled monoglycerides and mono- and diglycerides are commonly used emulsifiers in food products. Emulsifiers enable oil-soluble materials to be dispersed or suspended in highly polar or water-soluble matrices. They have a low HLB value (hydrophilic/lipophilic balance), hence, are readily dissolved in oil-soluble materials. They are also known to complex with starch to retard staling of bakery products. Any combination of above properties may render flavor granules to be less hygroscopic by modifying the macro and chemical environment surrounding the hygroscopic materials in such a way that water binding is reduced.

In one embodiment a flow agent, such as silicon dioxide, calcium stearate, and magnesium stearate are applied externally as a coating. The amount of flow agent employed according to the present invention is from about 1 to about 2% by weight. One type of silicon dioxide is Aerosil 200 manufactured by Degussa Corporation (Parsippany, N.J.) through a high temperature hydrolysis process. The flow agent may be applied as a direct coating to the flavor granule or as a secondary coating after applying a coating of triglycerides, glycerol triacetate, or other edible but water-insoluble fluids to the flavor granules.

Carrier materials such as, but not limited to, sugar, maltodextrin, dextrose and silicon dioxide and flavors are blended together in a mixer. This blend is introduced into a twin-screw extruder. There are different temperature and mixing/shear zones within the extruder that are designed to either feed, mix/emulsify, and/or heat transforming the blend into a viscous melt. The product inside the extruder is heated to a temperature sufficient to melt the sugar or carbohydrate in the matrix, typically up to about 120 to about 180° C.

The flavor particles prepared in accordance with the present invention preferably have a particle size distribution such that from about 60% to about 80% of the particles pass through about a US 20 mesh sieve after exposure to a humid environment. According to the present invention a humid environment is understood to exist when temperatures are above about 20° C. and above about 50% relative humidity, more preferably at about 30° C. and about 60% relative humidity.

The free flowing flavor granules may also be combined with tea leaves. This mixture may be used to fill tea bags, which may be made of porous materials such as paper, cellulose and mixtures thereof and provide flavored tea bags wherein the free flowing flavor granules do not stick to the tea bags and not produce any visible spots on the tea bags. In one embodiment the ratio of the amount of the free flowing flavor granules to the amount of cut tea leaves is about 1:10.

The following are provided as specific embodiments of the present invention. Other modifications of this invention will be readily apparent to those skilled in the art. Such modifications are understood to be within the scope of this invention. As used herein all percentages are weight percent unless otherwise noted, ppm is understood to mean parts per million; mm is understood to be millimeters, ml is understood to be milliliters, Bp is understood to be boiling point. IFF as used in the examples is understood to mean International Flavors & Fragrances Inc., New York, N.Y., USA.

In order to demonstrate the invention, the following examples were conducted. All U.S. patent and patent applications referenced herein are hereby incorporated by reference as if set forth in their entirety. The following disclosures are provided to exemplify the present invention.

Unless noted to the contrary all weights are weight percent. Upon review of the foregoing, numerous adaptations, modifications and alterations will occur to the reviewer. These adaptations, modifications, and alterations will all be within the spirit of the invention. Accordingly, reference should be made to the appended claims in order to ascertain the scope of the present invention.

All formulations are expressed as percentage by weight. Observations after 24 hours were based on subjecting the sample to the moisture resistance test to determine the hygroscopic property of the particles, wherein a 2-gram sample is weighed into an aluminum dish and kept in a humidity chamber set to conditions of 30° C. and 60% relative humidity. The terms moisture resistance test and hygroscopicity testing are used interchangeably in the following examples. Samples were also tested to determine the percentage of material that would pass through a US 20 mesh sieve after storage at above condition. For this test, a 5-gram sample is weighed into an aluminum dish and kept in a humidity chamber set to conditions of 30° C. and 60% relative humidity. After a 24 hour period, each sample was removed and placed on a US 20 mesh sieve with a bottom pan. This system was then placed in a Ro-Tap® unit (W. S. Tyler) for 1 minute. All samples tested originally have a particle size range of −20/+60 US mesh or 0.25 to 0.84 mm. The amount of material passing through the US 20 mesh sieve is a direct measure of the moisture resistance of the formulation. Particles that pass through a 20 mesh sieve have a particle size of about less than 0.84 mm or 840 microns.

### EXAMPLE 1

The following formulations were processed via extrusion:

| | 1 | 2 | 3 | 4 |
|---|---|---|---|---|
| Ingredients | | | | |
| Sugar | 35.2 | 35.2 | 37.4 | 41.2 |
| Maltodextrin | 39.2 | 38.2 | 40.4 | 41.2 |
| Dextrose | 10.1 | 10.1 | 10.7 | 10.1 |
| Silicon Dioxide | 3.5 | 4.5 | 4.5 | 2.5 |
| Lecithin | 2.0 | 2.0 | 2.0 | 0 |
| Orange Flavor | 10.0 | 0 | 0 | 0 |
| Raspberry Flavor | 0 | 10.0 | 0 | 0 |
| Lemon Flavor | 0 | 0 | 5.0 | 0 |
| Pomegranate Flavor | 0 | 0 | 0 | 5.0 |
| 24 Hr Observations | | | | |
| % Moisture | 4.50% | 5.50% | 4.10% | 6.75% |
| Pick-Up | | | | |
| Appearance | free- | free- | mostly free- | caked |
| Comments | flowing | flowing | flowing; | together |
| | particles | particles | slightly | |
| | | | clumpy | |
| % Through 20 | 98.85% | 97.92% | 98.08% | 0.00% |
| US mesh | | | | |

(Extruder zone temperatures, ° C.: Z1 = 0, Z2 = 0, Z3 = 120, Z4 = 180, Z5 = 180, Z6 = 170, Z7 = 150, Z8 = 120, Die Block = 125). After extrusion, the products were blended with 2% silicon dioxide.

From this example, it is seen that flavor granules absorb different levels of moisture. The amount of moisture absorbed is not always a clear indication of the tendency of the granule to become sticky. The same is true for flavor type. Although both Orange 1 and Lemon 3 are citrus type flavors, Orange 1 absorbs 4.50% moisture and still remains free-flowing, while Lemon 3 absorbs less moisture but the particles tend to clump together.

### EXAMPLE 2

The following formulations were processed via extrusion:

| | 4 | 5 | 6 | 7 | 8 | 9 |
|---|---|---|---|---|---|---|
| Ingredients | | | | | | |
| Sugar | 41.2 | 40.2 | 40.2 | 40.2 | 40.6 | 38.8 |
| Maltodextrin | 41.2 | 40.2 | 40.2 | 40.2 | 41.6 | 40.6 |
| Dextrose | 10.1 | 10.1 | 10.1 | 10.1 | 11.6 | 11.2 |
| Silicon Dioxide | 2.5 | 2.5 | 2.5 | 2.5 | 1.8 | 2.7 |
| Lecithin | 0 | 0 | 0 | 0 | 0.7 | 1.0 |
| Pomegranate | 5.0 | 5.0 | 5.0 | 5.0 | 0 | 0 |
| Flavor | | | | | | |
| Microcrystalline | 0 | 2.0 | 0 | 0 | 0 | 0 |
| Cellulose | | | | | | |
| Sodium Carboxy- | 0 | 0 | 2.0 | 0 | 0 | 0 |
| methylcellulose | | | | | | |
| Distilled | 0 | 0 | 0 | 2.0 | 0 | 0 |
| Monoglycerides | | | | | | |
| Apple Flavor | 0 | 0 | 0 | 0 | 3.7 | 3.7 |
| Triglycerides | 0 | 0 | 0 | 0 | 0 | 2.0 |
| 24 Hr | | | | | | |
| Observations | | | | | | |
| % Moisture Pick- | 7.95% | 7.67% | 7.09% | 7.26% | 7.42% | 6.92% |
| Up | | | | | | |
| Appearance | Caked | caked | free- | free- | caked | free- |
| Comments | together; | together; | flowing; | flowing; | | flowing; |
| | losing | particle | slightly | slightly | | slightly |
| | particle | identity | clumpy | clumpy | | clumpy |
| | identity | remains | | | | |
| % Through 20 US | 0.00% | 8.52% | 85.23% | 97.56% | 7.81% | 58.96% |
| mesh | | | | | | |

(Extruder zone temperatures, ° C.: Z1 = 0, Z2 = 0, Z3 = 120, Z4 = 180, Z5 = 180, Z6 = 170, Z7 = 150, Z8 = 120, Die Block = 125). After extrusion, the products were blended with 2% silicon dioxide.

From this example, it is seen that the addition of such functional ingredients helps to reduce the level of moisture flavor granules absorb. More importantly, their addition also helps the flavor granules to retain particle integrity even after absorbing some moisture. From this example, it is seen that microcrystalline cellulose (Pomegranate 5) is not as effective as sodium carboxymethylcellulose (Pomegranate 6) or distilled monoglycerides (Pomegranate 7) in retaining particle integrity.

### EXAMPLE 3

The presence of a functional ingredient and a silicon dioxide coating works in synergy to help reduce moisture absorption and retain the particle integrity of the encapsulate. Pomegranate 4 and Pomegranate 6 from Example 2 were tested with and without a 2% silicon dioxide coating at 30° C. and 60% relative humidity.

| 6 Hr | 4 (no | 4 | 6 (no | 6 |
|---|---|---|---|---|
| Observations | coating) | (w/coating) | coating) | (w/coating) |
| % Moisture | 5.79% | 6.58% | 5.20% | 5.52% |
| Pick-Up | | | | |
| Appearance | paste; no | Caked | paste; slight | free- |
| Comments | particle | | particle | flowing |
| | identity | | identity | |
| % Through 20 | 0% | 0% | 0% | 99% |
| US mesh | | | | |

In both cases, the presence of a silicon dioxide coating helped to improve the appearance of the flavor granules after being subjected to such harsh conditions. The presence of the functional ingredient in Pomegranate 6 also helped to improve the hygroscopic tendencies of the granule. The best result is seen with Pomegranate 6 (w/coating) where the presence of sodium carboxymethylcellulose and the silicon dioxide coating work in synergy to keep the particles free-flowing.

### EXAMPLE 4

The following formulation was processed via extrusion:

| | 4 | 6 | 10 | 11 | 12 | 13 | 14 |
|---|---|---|---|---|---|---|---|
| Ingredients | | | | | | | |
| Sugar | 41.2 | 40.2 | 41.7 | 40.7 | 34.5 | 33.7 | 36.7 |
| Maltodextrin | 41.2 | 40.2 | 41.7 | 40.7 | 39.5 | 38.7 | 40.6 |
| Dextrose | 10.1 | 10.1 | 10.1 | 10.1 | 9.9 | 9.7 | 10.1 |
| Silicon Dioxide | 2.5 | 2.5 | 2.0 | 2.0 | 4.0 | 4.0 | 3.0 |
| Lecithin | 0 | 0 | 1.0 | 1.0 | 2.0 | 2.0 | 2.0 |
| Pomegranate | 5.0 | 5.0 | 0 | 0 | 0 | 0 | 0 |
| Flavor | | | | | | | |
| Sodium Carboxy- | 0 | 2.0 | 0 | 2.0 | 0 | 2.0 | 2.0 |
| methylcellulose | | | | | | | |
| Pineapple Flavor | 0 | 0 | 3.6 | 3.6 | 0 | 0 | 0 |
| Honey Flavor | 0 | 0 | 0 | 0 | 10.0 | 10.0 | 0 |
| Passion Fruit | 0 | 0 | 0 | 0 | 0 | 0 | 5.6 |
| Flavor | | | | | | | |
| 24 Hr | | | | | | | |
| Observations | | | | | | | |
| % Moisture Pick- | 7.95% | 7.09% | 8.26% | 6.03% | 6.90% | 4.51% | 6.24% |
| Up | | | | | | | |
| Appearance | caked | free- | caked | free- | caked, | hard, | free- |
| Comments | together; | flowing; | | flowing | gummy | very | flowing |
| | losing | slightly | | | particles | clumpy | |
| | particle | clumpy | | | | particles | |
| | identity | | | | | | |
| % Through 20 US | 0.00% | 85.23% | 7.72% | 92.84% | 0.00% | 69.60% | 99.06% |
| mesh | | | | | | | |

(Extruder zone temperatures, ° C.: Z1 = 0, Z2 = 0, Z3 = 120, Z4 = 180, Z5 = 180, Z6 = 170, Z7 = 150, Z8 = 120, Die Block = 125). After extrusion, the products were blended with 2% silicon dioxide.

From this example, it can be seen that the addition of a functional ingredient, such as sodium carboxymethylcellulose, greatly reduces the hygroscopic tendencies of amorphous flavor granules regardless of the flavor used.

### EXAMPLE 5

Passion Fruit 14 from Example 4 was incorporated into tea leaves at 10% by weight. This mixture was filled into tea bags, placed in the overwrap, and put into paperboard tea boxes. These boxes were then subjected to conditions of 30° C. and 60% relative humidity. After 10 days, the tea bags were evaluated. The tea bags did not stick to the overwrap and there were no visible spots.

### EXAMPLE 6

The following formulation was processed via extrusion:

| Ingredients | 15 |
|---|---|
| Sugar | 41.1 |
| Maltodextrin | 42.1 |
| Dextrose | 11.8 |
| Silicon Dioxide | 1.5 |
| Blueberry Flavor | 3.5 |

(Extruder zone temperatures, ° C.: Z1 = 0, Z2 = 0, Z3 = 120, Z4 = 180, Z5 = 180, Z6 = 170, Z7 = 150, Z8 = 120, Die Block = 125)

### EXAMPLE 7

Product from Example 6 was blended with 2% silicon dioxide prior to hygroscopicity testing. This product was then placed in an aluminum dish and subjected to conditions of 30° C. and 60% relative humidity. Within 24 hours it had absorbed approximately 8.53% moisture and had formed a paste.

### EXAMPLE 8

Product from Example 6 was first thoroughly mixed with 5% medium chain triglycerides and then blended with 2% silicon dioxide prior to hygroscopicity testing. This product was then placed in an aluminum dish and subjected to conditions of 30° C. and 60% relative humidity. Within 24 hours it had absorbed approx. 7.72% moisture. Although the product appeared to be caked at first glance, it broke apart to be free-flowing/clumpy particles with a small shake of the pan.

### EXAMPLE 9

Product from Example 6 was first thoroughly mixed with 5% glycerol triacetate and then blended with 2% silicon dioxide prior to hygroscopicity testing. This product was then placed in an aluminum dish and subjected to conditions of 30° C. and 60% relative humidity. Within 24 hours it had absorbed approx. 6.07% moisture and remained as free-flowing, slightly clumpy particles.

We claim:

1. A method of forming a free flowing granule flavor composition comprising
a. mixing in any order the following ingredients a flavor, a carrier, and a functional ingredient selected from the group consisting of distilled monoglycerides, mono- and diglycerides, sodium carboxymethylcellulose, hydroxypropylcellulose, methylcellulose, hydroxypropyl methylcellulose, ethylcellulose, silicon dioxide, calcium stearate, magnesium stearate;
b. extruding the ingredients at a temperature sufficient to form a melt which on cooling solidifies and reduced in size to form a granule material having said flavor oil entrapped herein;
c. milling the extruded ingredients to a particle size of about 0.1 to 10 millimeters;
d. optionally blending the extruded ingredients with a flow agent;
e. optionally coating the extruded ingredients with an edible but water-insoluble fluid followed by blending with a flow agent; and
f. providing free flowing granule flavors.

2. The method of claim 1 wherein the flavor granules having a particle size distribution such that about 60% of the particles pass through a 20 mesh screen, US ASTM sieve size, after exposure to humid environments.

3. The method of claim 1 wherein the flavor granules having a particle size distribution such that about 80% of the particles pass through a 20 mesh screen, US ASTM sieve size, after exposure to humid environments.

4. The method of claim 1 wherein the ingredients are extruded at a temperature of not more than about 200° C.

5. The method of claim 1 wherein the functional ingredient is sodium carboxymethylcellulose.

6. The method of claim 1 wherein the functional ingredient is distilled monoglycerides.

7. The method of claim 1 wherein the flow agent is silicon dioxide.

8. The method of claim 1 wherein the water-insoluble fluid is selected from triglycerides, glycerol triacetate and mixtures thereof.

9. The method of claim 1 wherein the functional ingredient represents from about 0.1 to about 10% by weight relative to the dried granular system.

10. The method of claim 1 wherein the flavor ingredient or composition represents from about 0.1 to about 30% by weight relative to the dried granular system.

11. The method of claim 1 wherein the flavor granules retain particle shape and integrity when exposed to temperatures above about 20° C. and above about 50% relative humidity for a period of about 24 hours.

12. A tea bag and an amount of cut tea leaves sufficient to brew a preselected portion of tea, wherein the tea bag contains an amount of the free flowing flavor granules prepared according to the method of claim 1 sufficient to impart the preselected portion of brewed tea the flavor of the flavor oil.

13. A tea bag as claimed in claim 12 wherein the ratio of the amount of the free flowing flavor granules to the amount of cut tea leaves is about 1:10.
